(19) United States
(12) Patent Application Publication
(10) Pub. No.: US 2025/0096374 A1
(43) Pub. Date: Mar. 20, 2025

(54) POUCH EXTERIOR MATERIAL CAPABLE OF REDUCING BATTERY SWELLING AND MANUFACTURING METHOD THEREOF

(71) Applicant: REPUBLIC OF KOREA (NATIONAL FORENSIC SERVICE DIRECTOR MINISTRY OF THE INTERIOR AND SAFETY), Wonju-si (KR)

(72) Inventors: Hyun Won LEE, Daejeon (KR); Dong Gyu LEE, Daejeon (KR); Gie Tae LEE, Jincheon-gun (KR); Seung Woo WOO, Wonju-si (KR); Jong Taek PARK, Wonju-si (KR)

(21) Appl. No.: 18/663,320

(22) Filed: May 14, 2024

(30) Foreign Application Priority Data
Sep. 18, 2023 (KR) 10-2023-0123913

(51) Int. Cl. H01M 50/129; H01M 50/105; H01M 50/119; H01M 50/121

(52) U.S. Cl. CPC H01M 50/129; H01M 50/105; H01M 50/119; H01M 50/121

(57) ABSTRACT

A pouch exterior material of a pouch-type battery capable of reducing battery swelling includes a resin layer located inside the pouch-type battery, a metal layer stacked on the resin layer, an insulating layer stacked on the metal layer, and a pattern layer of an elastic material formed on the insulating layer.

### CROSS-REFERENCE TO RELATED APPLICATIONS

The present application is based on and claims priority to Korean Patent Application No. 10-2023-0123913, filed on Sep. 18, 2023, in the Korean Intellectual Property Office, which is incorporated herein by reference in its entirety.

### BACKGROUND

### 1. Field

One or more embodiments relate to a pouch exterior material capable of reducing battery swelling and a manufacturing method thereof.

### 2. Description of the Related Art

The importance of secondary batteries, which are used as a key component for energy supply in electric vehicles (EVs), mobile phones, wearable devices, and portable PCs, is increasing. Among secondary batteries capable of charging and discharging, the use of lithium secondary batteries, which have excellent energy density characteristics, is increasing.

Lithium secondary batteries are classified into cylindrical, prismatic, and pouch-type batteries depending on the exterior material, and pouch-type batteries may be customized to suit needs in various sizes.

The utilization of pouch-type batteries is increasing because they have high energy density and may be custom-made in various sizes. However, in pouch-type batteries, the electrolyte inside the battery decomposes and gas is generated due to various factors such as overcharging, overdischarging, manufacturing defects, physical damage, and exposure to high temperatures, which increases internal pressure. As a result, a swelling phenomenon occurs where the pouch swells, increasing the possibility of fire or explosion.

### Patent Document

Korean Patent No. 10-0716596 (registered on May 3, 2007)

### SUMMARY

One or more embodiments include a pouch exterior material capable of reducing battery swelling and a manufacturing method thereof to ensure safety and performance by improving a pouch exterior material of a battery and increasing the external strength due to swelling.

One or more embodiments include a pouch exterior material capable of reducing battery swelling and a manufacturing method thereof that are easy to develop by adding a pattern layer formation operation to an existing pouch exterior material process operation.

According to one or more embodiments, a pouch exterior material of a pouch-type battery capable of reducing battery swelling includes a resin layer located inside the pouch-type battery, a metal layer stacked on the resin layer, an insulating layer stacked on the metal layer, and a pattern layer of an elastic material formed on the insulating layer.

In an embodiment, the resin layer may be polypropylene (PP) or casted polypropylene (CPP).

In an embodiment, the metal layer may be at least one of an alloy of iron (Fe), carbon (C), chromium (Cr) and manganese (Mn), an alloy of iron (Fe), carbon (C), chromium (Cr) and nickel (Ni), and aluminum (Al).

In an embodiment, the insulating layer may be nylon or polyethylene-terephthalate (PET).

In an embodiment, a pattern shape of the pattern layer may include a grid or radial shape.

In an embodiment, the elastic material may be at least one of natural rubber (NR), styrene-butadiene rubber (SBR), polybutadiene rubber (BR), nitrile-butadiene rubber (NBR), solution styrene butadiene rubber (SSBR), neoprene (CR), ethylene propylene rubber (EPR), ethylene propylene diene monomer (EPDM), silicone, and silicone elastomer.

According to one or more embodiments, a method of manufacturing a pouch exterior material may include forming and sequentially stacking a resin layer, a metal layer, and an insulating layer, and forming a pattern layer of an elastic material on the insulating layer.

In an embodiment, the pattern of the pattern layer may include a grid or radial shape.

In an embodiment, the elastic material may be at least one of NR, SBR, BR, NBR, SSBR, CR, EPR, EPDM, silicone, and silicone elastomer.

In an embodiment, the forming of the pattern layer may include bar-coating the elastic material using a pattern mold or injecting the elastic material into the pattern mold at high pressure.

According to one or more embodiments, a method of manufacturing a pouch exterior material includes forming a resin layer, a metal layer, and an insulating layer and sequentially stacking them, forming a pattern layer of elastic material on the insulating layer, and accommodating and sealing an electrode assembly including an anode, a cathode, a separator, and an electrolyte.

Additional aspects will be set forth in part in the description which follows and, in part, will be apparent from the description, or may be learned by practice of the embodiments.

### BRIEF DESCRIPTION OF THE DRAWINGS

These and/or other aspects will become apparent and more readily appreciated from the following description of the embodiments, taken in conjunction with the accompanying drawings in which:

FIG. 1 is a schematic view of a battery including a pouch exterior material, according to an embodiment;

FIG. 2 is a schematic view of a stack structure of a pouch exterior material, according to an embodiment;

FIGS. 3A and 3B are schematic views of patterns of a pouch exterior material, according to embodiments; and

FIGS. 4A and 4B are flowcharts schematically showing a method of manufacturing a pouch-type battery, according to embodiments.

### DETAILED DESCRIPTION

Hereinafter, embodiments will be described in detail with reference to the accompanying drawings. The same reference numerals are used to denote the same elements, and repeated descriptions thereof will be omitted.

It will be understood that although the terms “first,” “second,” etc. may be used herein to describe various components, these components should not be limited by these terms.

An expression used in the singular encompasses the expression of the plural, unless it has a clearly different meaning in the context.

It will be further understood that the terms “comprises” and/or “comprising” used herein specify the presence of stated features or components, but do not preclude the presence or addition of one or more other features or components.

It will be understood that when a layer, region, or component is referred to as being “formed on” another layer, region, or component, it can be directly or indirectly formed on the other layer, region, or component. That is, for example, intervening layers, regions, or components may be present.

Sizes of components in the drawings may be exaggerated for convenience of explanation. In other words, since sizes and thicknesses of components in the drawings are arbitrarily illustrated for convenience of explanation, the following embodiments are not limited thereto.

When a certain embodiment may be implemented differently, a specific process order may be performed differently from the described order. For example, two consecutively described processes may be performed substantially at the same time or performed in an order opposite to the described order.

It will be understood that when a layer, region, or component is connected to another portion, the layer, region, or component may be directly connected to the portion or an intervening layer, region, or component may exist, such that the layer, region, or component may be indirectly connected to the portion.

Hereinafter, embodiments will be described in detail with reference to the accompanying drawings. The same reference numerals are used to denote the same elements, and repeated descriptions thereof will be omitted.

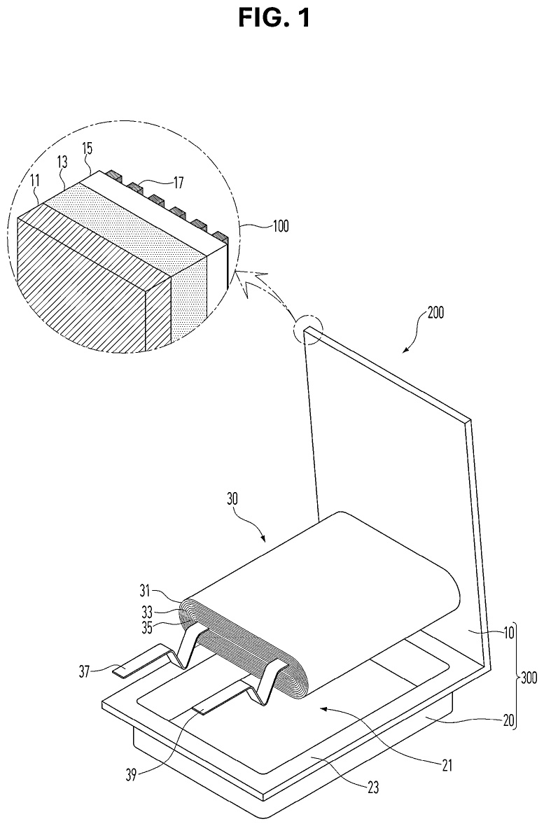

Hereinafter, a pouch exterior material capable of reducing battery swelling will be described with reference to FIGS. 1 to 3B.

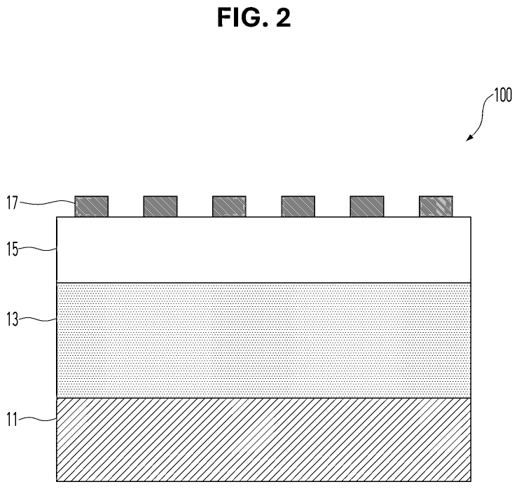

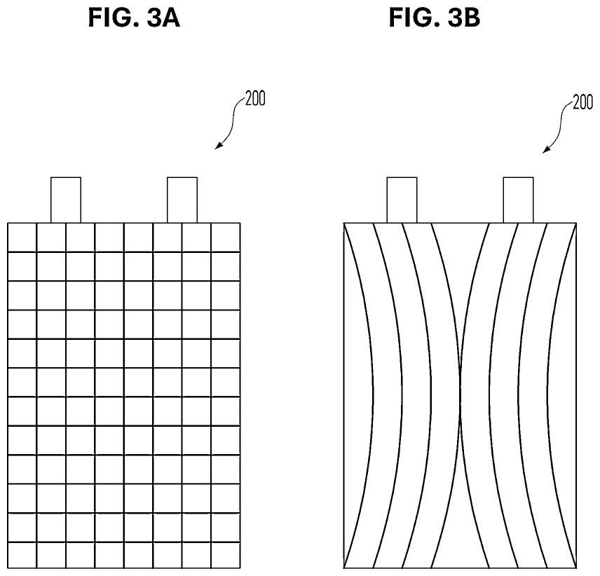

FIG. 1 is a schematic view of a battery including a pouch exterior material, according to an embodiment, and FIG. 2 is a schematic view of a stack structure of a pouch exterior material, according to an embodiment. FIGS. 3A and 3B are schematic views of patterns of a pouch exterior material, according to embodiments.

Referring to FIG. 1, a pouch-type battery 200 may include a pouch-type case 300 to which a pouch exterior material 100 is applied and an electrode assembly 30 accommodated in the pouch-type case 300. The pouch-type case 300 may be divided into an upper portion 10 and a lower portion 20 with an accommodation space 21 formed therein. The electrode assembly 30 may be built into the accommodation space 21. The electrode assembly 30 is formed by stacking and winding an anode 31, a cathode 35, and a separator 33. Electrode tabs 37 and 39 are drawn out from the anode 31 and cathode 35.

The pouch exterior material 100 according to an embodiment may include a resin layer 11, a metal layer 13, an insulating layer 15, and a pattern layer 17.

The resin layer 11 may be located inside the pouch-type battery 200 and may serve as a sealing material due to its thermal adhesiveness. The resin layer 11 may be any one of polypropylene (PP), casted polypropylene (CPP), or their equivalents, but is not limited to a specific material.

PP is a synthetic resin made by polymerizing propylene. PP has light weight, moisture resistance, and durability resulting from high tensile strength. PP does not emit environmental hormones, so safety may be ensured.

CPP has high gloss, transparency, and heat resistance, and is also cost-effective.

The metal layer 13 maintains mechanical strength of the pouch exterior material 100. The metal layer 13 may be any one of steel, aluminum, or equivalent materials, but is not limited to a specific material. For example, the metal layer 13 may be any one of an alloy of iron (Fe), carbon (C), chromium (Cr) and manganese (Mn), an alloy of Fe, C, Cr and nickel (Ni), and aluminum (Al). Among these, the metal layer is most preferably formed of aluminum.

Aluminum is a highly versatile metal, resistant to low temperatures, and lightweight. Although aluminum is lightweight, it has a high strength-to-weight ratio. In addition, aluminum is malleable and ductile and may be formed into desired shapes using various technologies such as casting, forging, rolling, extrusion, and bending. A melting point of aluminum is approximately 660° C., which makes it possible to manufacture complex shapes due to its relatively low melting point compared to iron (melting point 1530° C.).

The insulating layer 15 may be any one of nylon, polyethylene-terephthalate (PET), or an equivalent material, but is not limited to a specific material.

Nylon is a general term for polyamide-based synthetic polymer compounds. Nylon has excellent strength and durability, chemical resistance, flexibility, low friction, heat resistance, and lightness.

PET is a relatively high-density polyester resin and is crystalline or amorphous thermoplastic.

An adhesive may be used to connect the metal layer 13 and the resin layer 11 and to connect the metal layer 13 and the insulating layer 15.

For example, when the resin layer 11 is a PP layer, the adhesive used may be polypropylene adhesive, structural adhesive, polyolefin adhesive, heat-activated adhesive, etc.

The resin layer 11 and the insulating layer 15 are preferably 10 μm to 40 μm, and the metal layer 13 is preferably 20 μm to 100 μm. In addition, a corrosion prevention layer of 1 μm or less may be formed on one side and the other side of the metal layer 13.

Referring to FIGS. 3A and 3B, the pattern layer 17 is formed on the insulating layer 15 and is a layer formed in an arbitrary pattern.

The pattern layer 17 is made of an elastic material and may support the shape of the pouch-type battery 200 when pressure is applied during battery swelling.

The elastic material is a material that can be deformed by external force and is not limited to a specific material.

In an embodiment, the elastic material may be at least one of natural rubber (NR), styrene-butadiene rubber (SBR), polybutadiene rubber (BR), nitrile-butadiene rubber (NBR), solution styrene butadiene rubber (SSBR), neoprene (CR), ethylene propylene rubber (EPR), ethylene propylene diene monomer (EPDM), silicone, and silicone elastomer.

The shape of the pattern constituting the pattern layer 17 is not limited to a specific shape. For example, the shape of the pattern constituting the pattern layer 17 may include a grid or radial shape as shown in FIGS. 3A and 3B.

When the pattern layer 17 is not formed in the form of a pattern on the insulating layer 15 but is coated to cover the entire insulating layer 15 to form one layer, the increase in internal pressure may become excessively large and cause problems with the stability of the battery, which may result in thermal runaway. Thus, the pattern layer 17 is formed on the insulating layer 15 to counteract swelling in the center of the battery while minimizing the increase in internal pressure. By forming the pattern layer 17, both safety and performance of the pouch-type battery 200 may be secured.

In particular, in the case of the pattern layer 17 formed in a radial pattern, when gas is generated inside the pouch-type battery 200 and the pouch-type battery 200 swells, the swelling thickness at the center of the pouch-type battery 200 may be reduced.

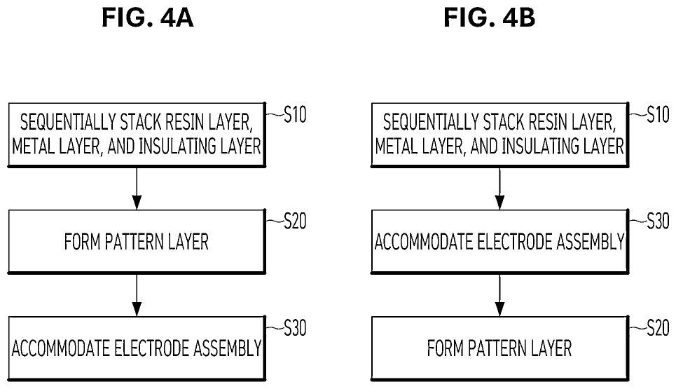

Hereinafter, a method of manufacturing a pouch exterior material and a pouch-type battery according to an embodiment will be described with reference to FIGS. 4A and 4B. FIGS. 4A and 4B are flowcharts schematically showing a method of manufacturing the pouch-type battery 200, according to embodiments.

Content that overlaps with the pouch exterior material 100 according to an embodiment described above will not be given herein. Because the method of manufacturing the pouch exterior material 100 is included in the method of manufacturing the pouch-type battery 200, it will be described together.

In operation S10, the resin layer 11, the metal layer 13, and the insulating layer 15 may be formed and sequentially stacked.

The resin layer 11, the metal layer 13, and the insulating layer 15 may be formed separately and stacked by applying adhesive to each layer and applying heat and pressure to adhere them. Adhesives may be selected considering the characteristics of each layer.

In more detail, one side of the resin layer 11 is located inside the pouch-type battery 200, and the other side of the resin layer 11 is stacked to correspond to one side of the metal layer 13. The other side of the metal layer 13 is stacked to correspond to one side of the insulating layer 15.

In operation S20, a pattern layer of elastic material may be formed on the insulating layer 15.

The elastic material is not limited to a specific material. In an embodiment, the elastic material may be at least one of NR, SBR, BR, NBR, SSBR, CR, EPR, EPDM, silicone, and silicone elastomer.

As an embodiment, in more detail, bar-coating may be performed by placing a pattern mold with an engraved pattern on the insulating layer 15 and forming a coating solution made by mixing an acrylic binder with silicone rubber in silicone elastomer. Thereafter, the pattern layer 17 may be formed by curing through UV coating.

As another embodiment, the pattern layer 17 may be formed by placing a pattern mold on the insulating layer 15 and injecting liquid silicone rubber at high pressure.

The method of forming the pattern layer 17 is not limited to a specific method as long as an arbitrary pattern can be formed on the insulating layer 15.

The pouch-type case 300 may be formed by stacking the resin layer 11, the metal layer 13, and the insulating layer 15 in operation S10, or may be formed after forming the pattern layer 17 on the insulating layer 15 in operation S20.

Thereafter, in operation S30, the electrode assembly 30 including the anode 31, the cathode 35, the separator 33, and the electrolyte may be accommodated and sealed.

In more detail, when the electrode assembly 30 is accommodated in the accommodation space 21 of the pouch-type case 300 in which the pattern layer 17 is formed and the inside of the upper portion 10 and the lower portion 20 of the pouch-type case 300 is heat-sealed, a sealing portion 23 is formed and adhered.

Operations S20 and S30 may be performed in reverse.

In more detail, the pouch-type case 300 may formed after forming and stacking the resin layer 11, the metal layer 13, and the insulating layer 15 in operation S10, and the pattern layer 17 may be formed in operation S20 after the electrode assembly 30 is accommodated and sealed in operation S30.

The pouch-type battery 200 to which the pouch exterior material 100 is applied is preferably a lithium secondary battery, but is not limited thereto.

According to embodiments, safety and performance may be secured by improving a pouch exterior material of a battery and increasing external strength due to swelling.

In addition, according to embodiments, process development may be easily performed by adding a pattern layer forming operation to an existing pouch exterior material processing operation.

The description herein is for the purpose of describing the inventive concept and numerous modifications and adaptations will be readily apparent to one of ordinary skill in the art without departing from the spirit and scope of the disclosure.

In this regard, the present embodiments may have different forms and should not be construed as being limited to the descriptions set forth herein. While the disclosure has been particularly shown and described with reference to embodiments thereof, it will be understood that various changes in form and details may be made therein without departing from the spirit and scope of the following claims.

What is claimed is:

1. A pouch exterior material of a pouch-type battery capable of reducing battery swelling, the pouch exterior material comprising:
a resin layer located inside the pouch-type battery;
a metal layer stacked on the resin layer;
an insulating layer stacked on the metal layer; and
a pattern layer of an elastic material formed on the insulating layer,
wherein the elastic material is at least one of natural rubber (NR), styrene-butadiene rubber (SBR), polybutadiene rubber (BR), nitrile-butadiene rubber (NBR), solution styrene butadiene rubber (SSBR), neoprene (CR), ethylene propylene rubber (EPR), ethylene propylene diene monomer (EPDM), silicone, and silicone elastomer.

2. The pouch exterior material of claim 1, wherein the resin layer is polypropylene (PP) or casted polypropylene (CPP).

3. The pouch exterior material of claim 1, wherein the metal layer is at least one of an alloy of iron (Fe), carbon (C), chromium (Cr) and manganese (Mn), an alloy of iron (Fe), carbon (C), chromium (Cr) and nickel (Ni), and aluminum (Al).

4. The pouch exterior material of claim 1, wherein the insulating layer is nylon or polyethylene-terephthalate (PET).

5. The pouch exterior material of claim 1, wherein a pattern shape of the pattern layer comprises a grid or radial shape.

6. A method of manufacturing a pouch exterior material, the method comprising:
forming a resin layer, a metal layer, and an insulating layer and sequentially stacking them; and
forming a pattern layer of elastic material on the insulating layer,
wherein the elastic material is at least one of natural rubber (NR), styrene-butadiene rubber (SBR), polybutadiene rubber (BR), nitrile-butadiene rubber (NBR), solution styrene butadiene rubber (SSBR), neoprene (CR), ethylene propylene rubber (EPR), ethylene propylene diene monomer (EPDM), silicone, and silicone elastomer.

7. The method of claim 6, wherein a pattern shape of the pattern layer comprises a grid or radial shape.

8. The method of claim 6, wherein the forming of the pattern layer comprises:
bar-coating the elastic material using a pattern mold or injecting the elastic material into the pattern mold at high pressure.

9. A method of manufacturing a pouch exterior material, the method comprising:
forming a resin layer, a metal layer, and an insulating layer and sequentially stacking them;
forming a pattern layer of elastic material on the insulating layer; and
accommodating and sealing an electrode assembly including an anode, a cathode, a separator, and an electrolyte,
wherein the elastic material is at least one of natural rubber (NR), styrene-butadiene rubber (SBR), polybutadiene rubber (BR), nitrile-butadiene rubber (NBR), solution styrene butadiene rubber (SSBR), neoprene (CR), ethylene propylene rubber (EPR), ethylene propylene diene monomer (EPDM), silicone, and silicone elastomer.
